(19) United States
(12) Patent Application Publication
(10) Pub. No.: US 2008/0123168 A1
(43) Pub. Date: May 29, 2008

(54) Mirror device modulating perpendicular incident light

(76) Inventors: Yoshihiro Maeda, Tokyo (JP); Fusao Ishii, Menlo Park, CA (US); Hirotoshi Ichikawa, Tokyo (JP); Yoshiaki Horikawa, Tokyo (JP)

Correspondence Address: Bo-In Lin, 13445 Mandoli Drive, Los Altos Hills, CA, 94022, US

(21) Appl. No.: 11/893,682

(22) Filed: Aug. 16, 2007

Related U.S. Application Data
(60) Provisional application No. 60/839,611, filed on Aug. 23, 2006.

(51) Int. Cl. G02B 26/02

(52) U.S. Cl. 359/223

(57) ABSTRACT

A display system includes a light source for projecting a linearly polarized illumination light. The display system further includes a deflectable mirror device having a plurality of mirror pixels. The display system further includes a polarized light separation plane that separates reflected light from the illumination light, a wave plate disposed near the deflectable mirror device, and a projection lens that projects the reflected light from the deflectable mirror device. In this system, the optical axes of the illumination light and an ON reflected light reflected from the deflectable mirror device are substantially perpendicular to the deflectable mirror device, and the optical axis of an OFF reflected light is inclined to the optical axis of the image display projection light path.

This application is a Non-provisional application and claims the Priority Date of a Provisional Application 60/839,611 filed on Aug. 23, 2006 by the same Inventors of this Non-provisional application.

### TECHNICAL FIELD

The present invention relates to a display system using a deflectable mirror device. More particularly, this invention relates to an image display system implemented with a mirror device for modulating perpendicular incident light to achieve simplified and compact optical system for the image display systems.

### BACKGROUND ART

Conventional display systems have been implemented with display image control by using LCOS (Liquid Crystal On Silicon), and a deflectable mirror device, such as DMD (Digital Micromirror Device). In the display system implemented with the LCOS image control, the LCOS changes the polarization direction of linearly-polarized illumination light to modulate the amount of light. When the LCOS is employed to carry out the function of a reflective SLM (Spatial Light Modulator), part of the light path of an illumination light is shared with the light path of the reflected light.

Specifically, when the LCOS is employed for image display control, the reflected light path of the ON and OFF light coincide with the optical axis of a projection optics. A PBS (Polarizing Beam Splitter) is used to separate the light path of light modulated as an ON light from the light path of OFF light. Therefore, in a LCOS system, when the polarization states of the incident illumination light and the reflected light are not well manage and becomes disordered somewhere in the light paths, the light that should be OFF and projected away from the optical path of image display will be projected into the image display optical path to generate unfavorable interferences with the image display light. This results in degradation in the image quality, particularly, reduction in contrast of the display images.

On the other hand, the systems using a deflectable mirror device may not necessary use polarized light. The mirror pixels in the deflectable mirror device deflect illumination light in two directions, ON and OFF directions. For example, U.S. Pat. No. 5,214,420, which will be further discussed below, discloses a deflectable mirror device-based system is implemented with display control system that uses a non-polarized illumination light.

FIG. 1A is a diagram for showing the basic configuration of a conventional image display system implemented with a deflectable mirror device. In the image display system shown in FIG. 1A, an incident light, which is random polarized light, is incident as illumination light in an oblique direction with respect to a normal to a deflectable mirror device (not shown). The deflectable mirror device includes mirror pixels to deflect the incident light in the ON or OFF direction. The light deflected in the ON direction, i.e., the projection light in FIG. 1A, enters a projection lens, while the light deflected in the OFF direction shown as the OFF light in FIG. 1A, is directed outside the projection lens. In FIG. 1A, character u denotes the angle that determines the NA (Numerical Aperture) of the projection lens. Character 0 denotes the angle of incidence of the incident light on the deflectable mirror device. In the system shown in FIG. 1A, the reflected is separated from the incident light when the condition of the following equation: θ≧2u is satisfied.

FIG. 1B shows the basic configuration of another conventional image display system implemented with another deflectable mirror device. In the system shown in FIG. 1B, light incident from a light source is incident on a TIR prism via incident light optics, and the incident light is reflected off from the TIR prism plane and incidents on a deflectable mirror device having a mirror array. The mirror array deflects the light incident on the deflectable mirror device in the ON or OFF direction as described above. The light deflected in the ON direction (projection (ON) light in FIG. 1B) passes through the TIR prism plane and enters a projection lens, while the light deflected in the OFF direction (the OFF light in FIG. 1B) passes through the TIR prism plane and is directed to a light dump. In the system shown in FIG. 1B, the TIR prism is thus used to separate the reflected light from the illumination light based on the angle of incidence of light incident on the TIR prism plane.

In the image display system implemented with a deflectable mirror device, it is necessary to prevent diffractive light from the grid-like mirror array from entering the projection optics. When the light source is a laser, in particular, the amount of diffractive light generated during transmitting through the light path is significant. The pitch between mirror pixels is as small as 10 to 14 μm, so that the adverse effect of diffractive light that may impact the quality of image display is significant.

As shown in FIG. 1C, the illumination light shown as the incident light in FIG. 1C, is incident on the mirror array along the diagonal direction of the substantially square mirror pixel. A light is diffracted in the direction that coincides with a side of the mirror and is perpendicular to the direction in which the illumination light is incident. The substantially square mirror pixel rotates around the diagonal of the mirror pixel. That is, the mirror pixel rotates around a deflecting axis in FIG. 1C as the axis of rotation. In such a configuration, when the mirror is rotated and the reflected light falls outside the pupil of the projection lens, the diffractive light generated in the direction that coincides with a side of the mirror is unlikely to enter the projection lens.

In the above conventional image display systems using deflectable mirror devices, since the illumination light and the reflected light are thus substantially inclined to each other in a three-dimensional manner, the optical components necessary to manage the optics of display image projections become large and complex. The degree of complexity is even more pronounced in a multiple-plate color system. The optical components necessary to manage the optics of light projections become particularly complex and expensive. For example, U.S. Pat. No. 4,680,579, which will be described later, discloses a Schlierin optics used to separate reflected light from non-polarized illumination light. This system has the disadvantage due to a poor light utilizing efficiency.

The following list includes technologies associated with conventional systems using deflectable mirror devices.

(1) U.S. Pat. No. 6,144,420 Jung (Assignee: Samsung Electronics Co., Ltd.)
This patent discloses the application of a ¼ wave plate for changing the a polarized light state.
   (2) U.S. Pat. No. 7,008,060 YAMAMOTO (Assignee: Fujinon Corporation)
This patent discloses a system that implements a ¼ wave-plate with the mirror device. However, the patent does not disclose the direction of incident light along an angular direction relative to the mirror pixel.
   (3) U.S. Pat. No. 5,214,420 Thompson et al. (Assignee: Texas Instruments)
This patent discloses an image display system displayed with a random polarity light.
   (4) U.S. Pat. No. 5,517,340 Fuad E. Doany et al. (Assignee: International Business Machines)
This patent discloses an image display system applying the polarized light for LCOS. There are no disclosures of a ¼λ plate and DMD.
   (5) U.S. Pat. No. 5,982,541 Li et al. (Assignee: National Research Council of Canada)
This patent discloses the TIR prism with thin film polarizing layer. However the patent discloses the use of the TIR and PBS system for only split the incident light and then combining the reflected light from multiple SLMs.
   (6) U.S. Pat. No. 7,004,587 Li et al. (Assignee: Himax Technologies, Inc.)
This patent discloses a system that uses a ¼ wave plate with LCOS panel.
   (7) U.S. Pat. No. 4,728,185 Thomas (Assignee: Texas Instruments)
This patent discloses a deflectable mirror device.
   (8) U.S. Pat. No. 4,680,579 Ott (Assignee: Texas Instruments)
This patent discloses a Schlierin optics using deflectable mirror.

### (9) JP2006-139263 Makiko Imae el al. (Konica Minolta)

This patent discloses the microscopic structure for a ¼ wave-plate. This patent does not disclose any functional utility for using a mirror device.

Therefore, a need still exists in the art of image display systems to provide an improved system configurations and optical transmission method to resolve the above-discussed problems and difficulties.

### SUMMARY OF THE INVENTION

It is one aspect of this invention to provide a display system using a deflectable mirror device wherein the illumination light is polarized with respect to the deflectable mirror device and passes through a wave plate and then is incident on the deflectable mirror device. The optical axis of the illumination light is set within the angle 2u that determines the NA of a projection optics and that is further within the angle u.

Another aspect of this invention is to provide an image display system with the illumination light is advantageously arranged to incident in the direction substantially perpendicular to the deflectable mirror device. The optical axis of reflected OFF light is inclined to the optical axis of the projection light path by at least 12 degrees, and preferably along a direction that is at least 15 degrees.

### BRIEF DESCRIPTION OF FIGURES

FIG. 1A is a side cross sectional view for showing the basic configuration of a conventional image display system using a deflectable mirror device;

FIG. 1B is a side cross sectional view for showing the basic configuration of another conventional image display system using a deflectable mirror device;

FIG. 1C a top view of a mirror array for showing the direction of an illumination light incident on a mirror array along an inclined angular direction;

FIG. 2 is a side cross sectional view for showing the key configuration of a display system using a deflectable mirror device according to a first embodiment of the invention;

FIG. 3A is a first view showing a cross section of one mirror pixel in a two-dimensional deflectable mirror array in a deflectable mirror device of a display system according to the first embodiment of the invention;

FIG. 3B is a second view showing a cross section of one mirror pixel in a two-dimensional deflectable mirror array in the deflectable mirror device of a display system according to the first embodiment of the invention;

FIG. 4A is a first cross sectional view for showing the configuration of a ¼λ plate;

FIG. 4B is a second cross sectional view for showing the configuration of a ¼λ plate;

FIG. 5 is a side cross sectional view for showing the key configuration of a display system using a deflectable mirror device according to a second embodiment of the invention;

FIG. 6 is a side cross sectional view for shows the key configuration of a display system using a deflectable mirror device according to a third embodiment of the invention;

FIG. 7A is a top view for showing a pixel array that modulates green illumination light;

FIG. 7B is a top view for showing a pixel array that modulates red and blue illumination light;

FIG. 7C is a partial enlarged top view of the pixel array shown in FIG. 7B; and

FIG. 8 is a side cross sectional view for showing the key configuration of a display system using a deflectable mirror device according to a fourth embodiment of the invention.

### DESCRIPTION OF PREFERRED EMBODIMENTS

Reference is now made to the above listed Figures for the purpose of describing, in detail, the preferred embodiments of the present invention. The Figures referred to and the accompanying descriptions are provided only as examples of the invention and are not intended in anyway to limit the scope of the claims appended to the detailed description of the embodiment.

In the drawings to be described below, the double circles and double-headed arrows are presented to indicate the polarization direction of light.

### First Embodiment

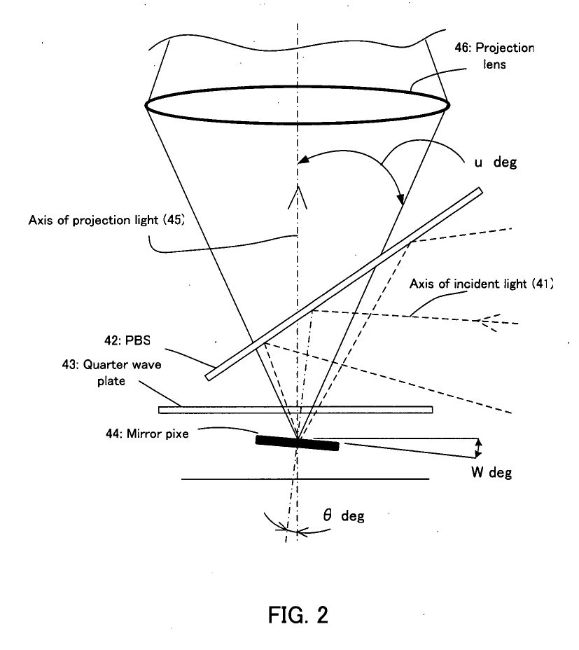

FIG. 2 is side cross sectional view to show the configuration of a display system implemented with a deflectable mirror device according to a first embodiment of the invention. In FIG. 2, a linearly-polarized illumination light is incident onto a fixed PBS (Polarizing Beam Splitter) 42. The PBS 42 reflects substantially all the light. The illumination light reflected off the PBS is directed to the deflectable mirror device 44. A ¼λ plate 43 is fixed between the PBS 42 and the deflectable mirror device 44. The light directed to the deflectable mirror device first passes through the ¼λ plate 43, is converted into circularly- or elliptically polarized light and reflected off a mirror pixel in the deflectable mirror device 44. It is noted that FIG. 2 shows only one mirror pixel in the deflectable mirror device 44 for convenience of explanation.

The light reflected off the mirror pixel in the deflectable mirror device passes through the same ¼λ plate 43 again where the direction of rotation of the circularly- or elliptically polarized light is reversed with respect to the direction of rotation before the reflection. The reflected light that has passed through the ¼λ plate is converted into linearly polarized light, the polarization direction of which differs from that of the illumination light by 90 degrees, and is incident on the PBS 42. The PBS 42 transmits almost all the reflected (projection) light incident thereon, and the transmitted light enters a projection lens 46. The projection lens 46 projects images on a screen (not shown).

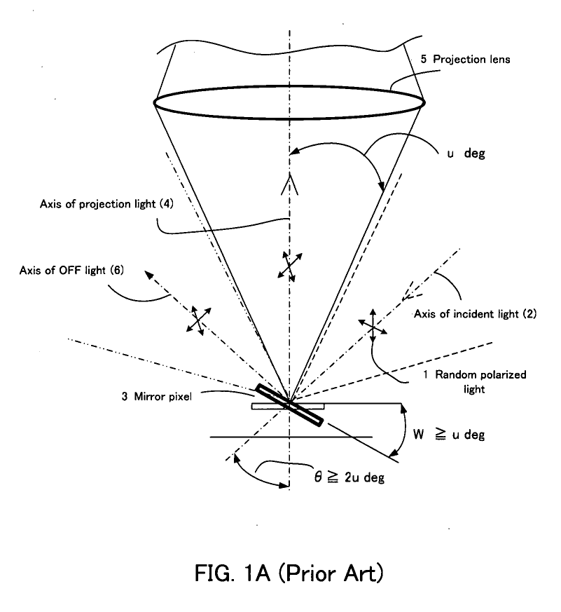

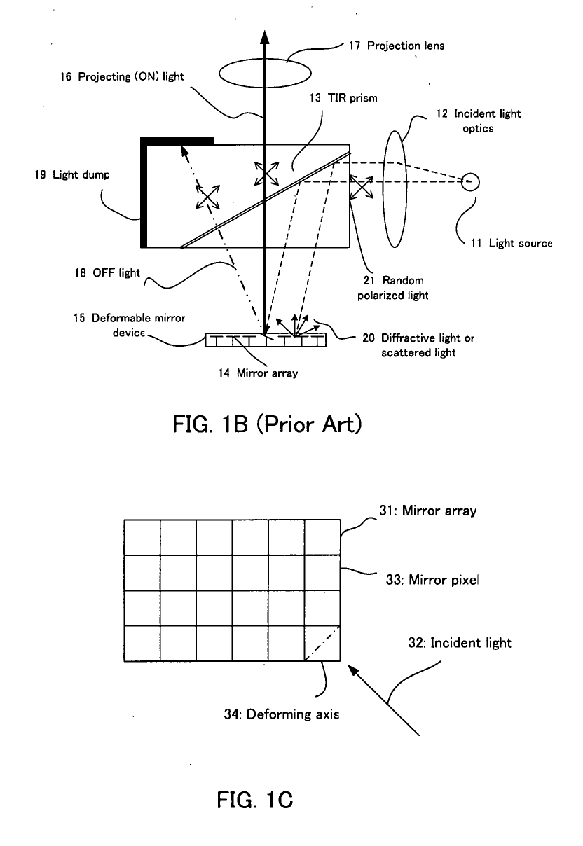

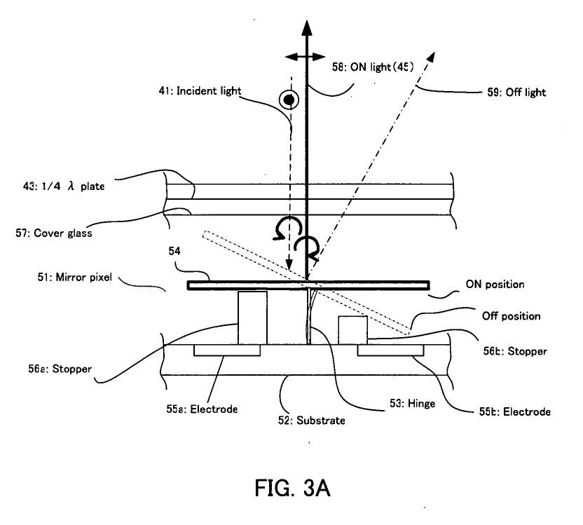

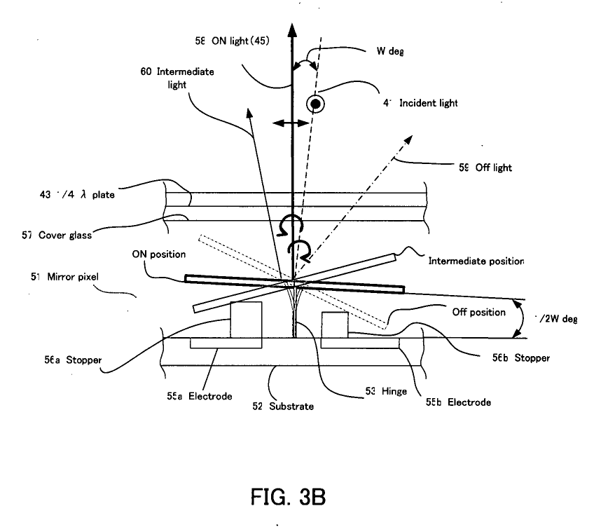

In the image display system described above, the illumination light is substantially perpendicular to the deflectable mirror device 44. Compared to an image display system when the incident light is not perpendicular to the deflectable mirror device, the illumination light is projected to the deflectable mirror device along an inclined angle u and this angle determines the NA of the projection lens or smaller. The deflecting angle of the mirror pixel W can therefore be smaller than or equal to (½)u. In contrast to a conventional system as shown in FIG. 1A, W≈u. Therefore, compared to the conventional systems, the deflecting angle of the mirror pixel W is therefore substantially half of the deflecting angle deflected from a conventional system. When the deflecting angle of the mirror pixel W is significantly reduce to half, the distance between an electrode and a mirror in the mirror pixel is also reduced to almost half of the distance as that required in a conventional system (see FIGS. 3A and 3B, which will be described later). The voltage for controlling the mirror pixel is proportional to the square of the distance. Therefore, when θ=u, the control voltage is reduced by a factor of approximately ¼. The mirror pixel in the conventional system requires a control voltage of about 25 V and hence the conventional display system requires a transistor with a high withstand voltage.

On the other hand, the mirror pixel in the present system can be formed by using a CMOS or NMOS circuit having a withstand voltage of 12 V or smaller and the circuit can be designed with smaller size. Hence the mirror pixel size can be as small as 5 to 10 μm

The configuration and operation of the mirror pixel will now be described with reference to FIGS. 3A and 3B.

FIG. 3A is a first side cross sectional view for showing a mirror pixel in a two-dimensional deflectable mirror array in the deflectable mirror device of the present system. FIG. 3A shows only the lower part below the PBS in FIG. 2. For example, when the two-dimensional deflectable mirror array is an HDTV-compliant deflectable mirror array, the mirror array includes 1920 by 1080 mirror pixels.

The mirror pixel shown in FIG. 3A has a vertical hinge 53 disposed on a substrate 52A mirror element formed as a reflective surface 54 is supported horizontally on the hinge 53. The mirror element is deflected under the influence of an electrostatic force when a voltage is applied to one of electrodes 55a and 55b disposed on both sides of the mirror element. The deflected mirror element comes to rest when it abuts a structure, such as a stopper, e.g, 56a and 56b.

In general, the mirror pixel modulates the illumination light in a binary manner in either an ON and OFF states. The mirror pixel of the present system is operable in an intermediate state to reduce the amount of reflected light reflected toward the projection lens from that of the ON state for modulating the amount of light. It is also possible to achieve modulation by oscillating the mirror element between ON and OFF or between ON and Intermediate in order to continuously change the amount of projection light.

In the mirror pixel shown in FIG. 3A, the ON state is defined as the state in which each mirror element is horizontally positioned in the deflectable mirror device (the ON position in FIG. 3A). Operation of the mirror at an ON state can be maintained by applying substantially no voltage to the mirror element. The projection light reflected from the mirror at an ON state is separated from the OFF light by tilting the mirror element in the OFF position in FIG. 3A. The mirror element 54 can also be oscillated between the ON and OFF states. In the oscillation state, the amount of light that passes through on the projection light path side changes in an analog manner. By controlling the number and period of the oscillation state allows the projection of an adjustable amount of intermediate light between ON and OFF states. The intermediate amounts of light can provide higher gray scales without increasing the voltage for driving the mirror element. Although FIG. 3A shows the incident light on the mirror element in such a way that the position where the incident light is incident differs from the position where the incident light is reflected for convenience of explanation. In practice, the positions coincide with each other.

FIG. 3B shows another exemplary embodiment of a display system that is different from the configuration shown in FIG. 3A. It represents another two-dimensional deflectable mirror array in the deflectable mirror device of the present system. In the mirror pixel shown in FIG. 3B, the illumination light is incident on the deflectable mirror device at an angle θ, shown as w degrees relative to the vertical axis perpendicular to the substrate (Please show where is this angle θ in FIG. 3B). The ON state is defined as the state in which the mirror element is inclined to the deflectable mirror device by the angle W=(½)*θ clockwise (the ON position in FIG. 3B), and the reflected light is directed substantially perpendicular to the deflectable mirror device. The OFF state is defined as the state in which the mirror pixel is further inclined clockwise (the OFF position in FIG. 3B), and in this case, the reflected light is not directed toward the projection lens. The intermediate state is defined as the state in which the mirror pixel is inclined counterclockwise (the Intermediate position in FIG. 3B), and reflected light having a smaller amount of light than that of the ON light directed toward the projection lens. Although FIG. 3B shows the incident light on the mirror element in the intermediate state in such a way that the position where the incident light is incident differs from the position where the incident light is reflected for convenience of explanation, in practice, the positions coincide with each other.

In the present system, as shown in FIGS. 3A and 3B, the ¼λ plate 43 is attached to a cover glass 57, which is a transparent window of the deflectable mirror device package. In this case, the ¼λ plate may be a sheet made of PVC (polyvinyl chloride) or of a similar material, or may be a coating provided on the cover glass 57. The ¼λ plate 43 may also be disposed on the underside of the cover glass. Alternatively, the ¼λ plate may be configured such that wave plates are disposed on the upper side and the underside of the cover glass so that the resultant structure is equivalent to a ¼λ plate when the illumination light passes through both the wave plates.

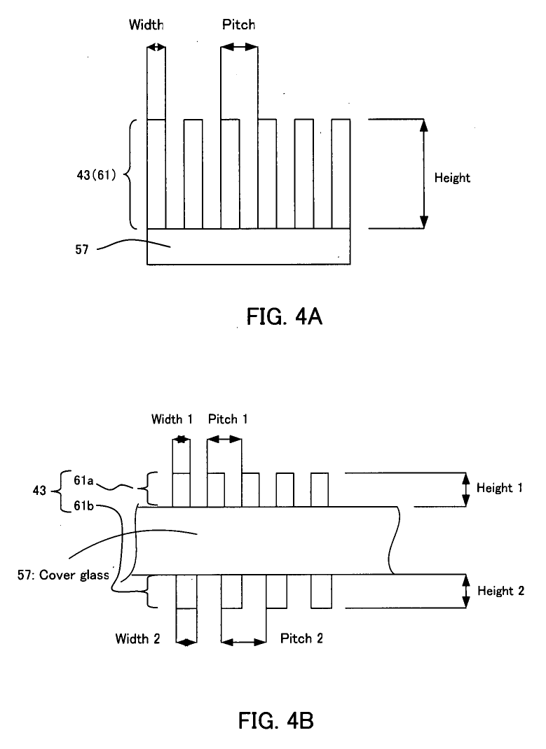

The ¼λ plate can also be configured as shown in FIG. 4A or 4B. The ¼λ plate shown in FIG. 4A is configured such that a structure having a dimension on the order of sub-wavelength is provided on the cover glass 57 of the deflectable mirror device package to exhibit the characteristics of a ¼λ plate. Instead of providing a wave plate on the cover glass 57, a wave plate can be provided on the surface of the mirror element in the mirror pixel 51. When the ¼λ plate is configured to have a structure shown in FIGS. 4A and 4B, the system can be configured in an inexpensive manner without increasing the number of components. The design of the ¼λ plate shown in FIG. 4A is determined by the width, pitch and height of the periodic structure. The ¼λ plate shown in FIG. 4B is configured such that the height of the periodic structure is lowered to form a two-layer structure so as to provide the characteristics of a ¼λ plate. In this case, when the present system includes a plurality of deflectable mirror devices, there may be provided a structure (Width 2, Pitch 2, Height 2) common to each of the deflectable mirror devices on the underside of the cover glass of the deflectable mirror device package and a wave plate (Width 1, Pitch 1, Height 1) having different characteristics on the upper side according to the conditions of the illumination wavelength, the optics and the like. In FIGS. 4A and 4B, the structure 61 or structures 61a and 61b provided on the upper side or on both the upper side and the underside of the cover glass 57 may be made of resin or ceramic having an optical function. Alternatively, the structure or structures may be formed directly on the glass 57.

In the present system, the illumination light incident on the gap between the mirror pixels at right angles reflects off the surface of the substrate, and part of the reflected light is directed in the same direction as the ON light. Although not shown in the figure, further configurations, such as attaching a film that shifts the phase of the polarized reflected light by another quarter wavelength to the surface of the substrate, using an AR coating or the like to absorb the light, and tilting the surface of the substrate, can prevent a projection of the unnecessary light.

### Second Embodiment

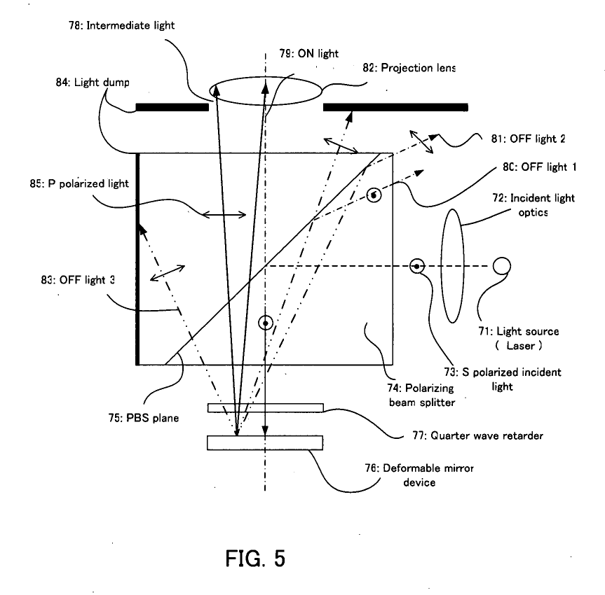

FIG. 5 shows the system configuration of an image display system using a deflectable mirror device according to a second embodiment of the invention.

In the system shown in FIG. 5, a laser light source 71 is used as the light source. Illumination light from the laser light source 71 is shaped into a desired light flux using incident light optics 72, such as a beam expander. In the laser light, the polarization directions are substantially aligned with each other (see the S polarized incident light 73 in FIG. 5). The illumination light 73 shaped into the desired light flux is deflected at the PBS plane 75 of a PBS 74 (Polarizing beam splitter) toward the deflectable mirror device 76. In the system shown in FIG. 5, the PBS plane 75 is disposed in such a way that it is inclined to the deflectable mirror device 76 by 45 degrees. The illumination light deflected at the PBS plane is incident on the deflectable mirror device 76 at right angles. Thus, in the present system, it is not necessary to shift the illumination light off the center and illuminate the mirror pixel in the diagonal direction as in the above conventional systems. The size of the prism optical member can therefore be reduced.

In the present system, to illuminate the entire deflectable mirror device with uniform illumination light, a diffraction grating or the like may be used as the incident light optics 72. Since phases are aligned with each other in the laser light, interference of light likely generates speckle patterns. To shift phases to eliminate this problem, various optical means (multiple reflection in an optical fiber or use of a diffuser) may be used in some cases. In this case, to realign the disordered linearly polarized light, a polarizer may be further added in front of the PBS. In the present system, the PBS 74 is a prism on which a dielectric film is formed to transmit or reflect the illumination light according to its polarization direction. A wire grid or a sub-wavelength fine periodic structure may be used. Alternatively, liquid crystal material may be used. When liquid crystal material is used, the direction of the polarization axis can be changed with time as appropriate.

The illumination light reflected off the PBS plane 75 of the PBS 74 passes through a ¼λ plate 77, is converted into circularly- or elliptically polarized light and incident on the deflectable mirror device 76. The light incident on each mirror pixel in the deflectable mirror device is reflected in the ON or OFF direction according to the deflection state of each mirror pixel. Furthermore, the illumination light is reflected in directions between ON and OFF (intermediate directions) (see the Intermediate light in FIG. 5). In FIG. 5, the OFF light is illustrated on the right and left sides. This is because the ON light is directed in the vertical direction, so that the OFF light can be set on either right or left side, according to the direction of rotation of the mirror pixel.

Since the OFF light is inclined to the ON light by a large angle, the polarization state of the OFF light that has passed through the ¼λ plate 77 differs from the linearly polarization state of the ON light. Part of the OFF light (see the OFF light 1 in FIG. 5) therefore does not pass through but reflects off the PBS plane 75, so that it is not directed toward the projection light path.

When the OFF light is directed in the right direction, the angle of incidence with respect to the inclined PBS plane becomes quite large. Therefore, even when the OFF light has the same linear polarization state as the ON light, the OFF light can be reflected off the PBS plane (see the OFF light 2 in FIG. 5). In this way, the OFF light can be certainly separated from the direction of the display light projected toward the projection lens therefore the display quality is improved.

On the other hand, when the OFF light is directed in the left direction, the angle of incidence with respect to the PBS plane approaches the right angle (see the OFF light 3 in FIG. 5). A light dump 84 is provided throughout the left side of the PBS prism 74. When the direction toward the light dump is the OFF direction, unnecessary light and the light projected from the mirrors directed toward the OFF direction can reliably be absorbed.

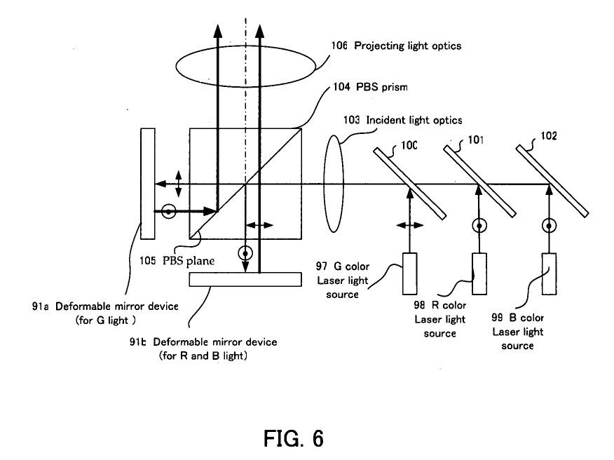

Furthermore, changing the structure of the deflectable mirror device 76 allows the optical axis of the OFF light to intersect the plane of FIG. 5. In this case, the mirror pixel is configured to be deflectable in two directions. The ON and Intermediate states lie in a plane parallel to the plane of FIG. 5, while the OFF state lies in a plane perpendicular to the plane of FIG. 5. This configuration is effective in a multiple-plate system shown in FIG. 6, which will be described later.

In the configuration described above, the ON light is reflected toward the projection lens in the most efficient manner. furthermore, the light not required for image display is projected to a different direction. Therefore, it is unlikely to project the light not required for image display toward the projection lens. Therefore, compared to systems using conventional deflectable mirror devices in which modulation is carried out based on only the reflection direction, the present system can provide images with improved contrast. Although FIGS. 5 and 6 show the incident light on the deflectable mirror device (76 in FIGS. 5 and 91a and 91b in FIG. 6) in such a way that the position where the light is incident differs from the position where the incident light is reflected for convenience of explanation, in practice, the positions coincide with each other.

### Third Embodiment

FIG. 6 shows the key configuration of a display system using a deflectable mirror device according to a third embodiment of the invention.

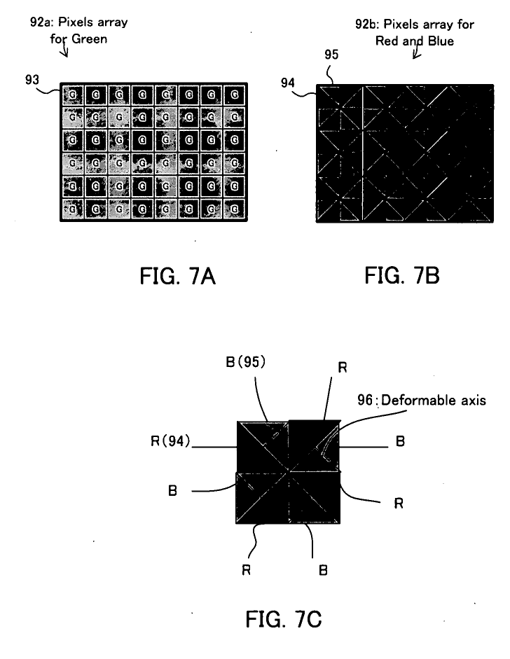

The system shown in FIG. 6 is a color display system using a plurality of deflectable mirror devices. The system actually uses two deflectable mirror devices 91a and 91b. FIGS. 7A and 7B show the configurations of pixel arrays in the deflectable mirror devices shown in FIG. 6.

The pixel array 92a shown in FIG. 7A modulates green illumination light. Each mirror pixel 93 is substantially square. The pixel array 92b shown in FIG. 7B modulates red and blue illumination light. Each of the mirror pixels 94 and 95 that modulate the red and blue illumination light is triangular and its area is about half that of the mirror pixel 93 for green light. To reflect or deflect only light of a specific color in the present system, sequential illumination of the red and blue illumination light easily allows color display.

Alternatively, there may be provided a blazed grating, a nanometer-wavelength periodic structure or a color filter on the surface of the mirror element in each of the mirror pixels. In this way, even when white illumination light is used, it is possible to reflect only light of a specific color in a predetermined direction. Furthermore, all the colors can be modulated at the same time. Moreover, by applying the red and blue illumination light to the deflectable mirror device at angles of incidence and directions different from each other, the reflection characteristics can be changed for each of the colors. The reflection direction of the OFF red light can be different from that of the OFF blue light.

In the pixel array 92b shown in FIG. 7B, the arrangement shown in FIG. 7C is employed to alternately arrange the colors. FIG. 7C shows only eight mirror pixels 94 and 95 corresponding to red (R) and blue (B). Specifically, the deflectable axis is alternately changed so that the deflecting directions of the mirror pixels are alternately changed, as shown in FIG. 7C. Furthermore, each mirror pixel is configured in such a way that there is no side perpendicular to the deflecting direction of the mirror pixel. In this way, diffractive light generated at the sides of the mirror will not likely enter the projection lens when the mirror is deflected. Moreover, since the mirrors corresponding to red and blue can be alternately arranged in the vertical, horizontal and diagonal directions, the image quality can be improved.

In the present system, as shown in FIG. 6, the polarization direction of the green illumination light 97 differs from those of the red 98 and blue illumination light 99. In this way, the green illumination light 97 beam passes through the PBS plane 105, while the red and blue illumination light beams reflect off the PBS plane 105. These light beams are then directed toward corresponding deflectable mirror devices 91a and 91b. In the present system, as in the other embodiments, the polarization direction of the reflected light is converted and reflected toward the projecting light optics.

Although not illustrated, the red and blue illumination lights share a wave plate disposed near the deflectable mirror device for the red and blue light. Therefore, the wave plate is designed to have more optimum characteristics for the red light than the blue light, which is more visible to the eye than the red light. However, the amount of blue light is smaller in some light sources. In this case, the wave plate may be optimized in such a way that the blue light can efficiently pass through the entire system.

Furthermore, the present system may be further configured according to a configuration described below. By setting the angles of deflection in the mirror pixels corresponding to the red and blue light different from each other, the amount of light that passes through the projection lens can also be changed for each pixel mirror corresponding to each color disposed in the same array. In this case, the amount of projection light may be set to an optimum value.

Although two deflectable mirror devices 91a and 91b are used in the present system, the system can be configured such that one deflectable mirror device is used to sequentially display RGB. For example, a conventional deflectable mirror device having square mirror pixels may be used to display the three colors, RGB, in a time division manner. In this case, the wave plate is optimized to an intermediate wavelength somewhere in the RGB color spectrum. In the present system, the polarization characteristics of the wave plate 77 may be changed in correspondence with the time division sequence of the illumination and modulation. Specifically, the wave plate 77 may be implemented with a polarization direction variable element, such as an LCD, and the polarization characteristics of the wave plate 77 can be changed.

### Fourth Embodiment

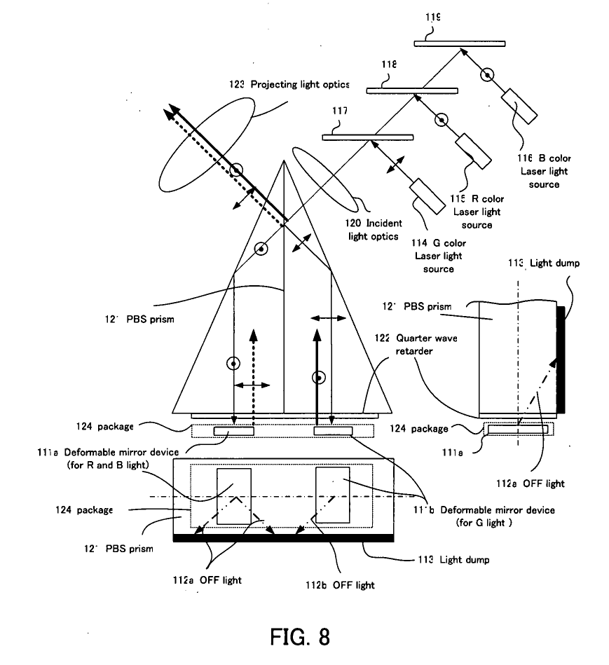

FIG. 8 is a functional diagram to show the key configuration of a display system using a deflectable mirror devices 111a and 111b according to a fourth embodiment of the invention. FIG. 8 also shows a partial right side view and a plan view. The system shown in FIG. 8 is an example of a system using a Koester type PBS prism 121. The deflectable mirror device and its sequence are the same as those shown in FIGS. 6, 7A, 7B and 7C.

In the system shown in FIG. 8, the illumination light path and reflected light path can be arranged in a coaxial manner, allowing the system to be efficiently laid out. In the conventional systems using non-polarized illumination light, the size of the prism inevitably increases because the illumination light path and reflected light path cannot be arranged in a coaxial manner. The present system however does not have such a problem.

In the present system, two deflectable mirror devices 111a and 111b can be disposed parallel to each other. In this way, the size of the prism does not have to substantially fit to the diagonal direction of the deflectable mirror device and hence the size of the prism can be determined by fitting the prism to the longer side or the shorter side of the deflectable mirror device, allowing reduction in size. In the present system, two deflectable mirror devices can also be laid out in the same package 124, so that misalignment between the deflectable mirror devices is reduced and hence beautiful images can be provided. In the present system, since only the OFF light 112a and 112b are reflected obliquely with respect to the optical axis of the projection light, the OFF light 112a and 112b are absorbed in a light dump 113 disposed along a side of the prism 121.

Thus, in the present system, since the layout is easily done and the OFF light does not exit toward the projection light path, the contrast can be improved. Although FIG. 8 shows the incident light on the deflectable mirror devices in such a way that the position where the light is incident differs from the position where the incident light is reflected for convenience of explanation, in practice, the positions coincide with each other.

Although the first to fourth embodiments of the invention have been described, in the system according to the second to fourth embodiments, since the polarization directions of light emitted from the laser light source are aligned with each other, it is not necessary to use a polarizer to convert the state of polarization. Furthermore, since laser light has a narrow wavelength band, the efficiency of converting linearly polarized light into circularly polarized light is high independent of the dependence of the wave plate on wavelength.

In the systems according to the second to fourth embodiments, although a laser light source is applied as the light source, an LED light source can be applied as the light source. Although an LED has a broad wavelength band, light emitted from each color LED can basically be handled as monochromatic light. Furthermore, the compactness of an LED provides degrees of freedom in the layout of the optics. However, since an LED light source radiates non-polarized light, a polarizer and a PS integrator or the like need to be disposed near the LED light source to convert the non-polarized light into linearly polarized light when a laser light source is replaced with an LED light source.

In the systems according to the first to fourth embodiments, the deflectable mirror device includes the mirror array, wherein the mirror array substrate is housed in a package provided with a transparent window or a transparent opening in order to shield the mirror array from ambient air. Alternatively, some deflectable mirror devices are configured as mirror array on a transparent glass substrate.

As the wave plate, a film made of PVC or the like may be attached to the transparent window. In this case, it is preferable that the refractive index of the film matches that of the transparent window for efficient light transmission. Furthermore, an AR coating may be coated on the surface of the wave plate. However, since some polymer materials have strong dependence on wavelength and hence the phase difference or transmission is substantially different among colors, two or more phase films may be used to compensate for the difference.

As an alternate embodiment of the wave plate, a thin film may be coated on the transparent window. As another embodiment of the wave plate, the transparent window may be shaped into a sub-wavelength periodic structure. As another embodiment of the wave plate, a resin sheet having a periodic structure may be attached to a transparent glass. In this case, the pitch of the periodic structure is about half the wavelength and the height thereof is about 1 to 2 μm. Alternatively, the height of the structure may be approximately halved and two sheets are joined at a predetermined angle.

Among the optical components that form the display system, the mirror array is positioned with the highest precision. By providing a wave plate in a package or on the transparent substrate, the optical axis of the wave plate can be accurately positioned with respect to the polarization direction of the illumination light. Alternatively, a wave plate having a periodic structure may be formed on the surface of the mirror. In this case, when the mirror pixel is deflected, the illumination light is incident on the surface of the mirror at a different angle of incidence. When the mirror pixel is in the ON state, the wave plate advantageously exhibits the optimum characteristics.

In the system according to the fourth embodiment, since the OFF light is not incident on the PBS plane because the polarized light has a separation plane of projection. As the OFF light is projected away from the PBS plane disposed on the projection light path side, images are now displayed with improved contrast.

In each mirror pixel in the deflectable mirror devices in the systems according to the first to fourth embodiments, the micromirror can be made of aluminum or of similar materials; the hinge can be made of silicon, aluminum, ceramic or of similar materials; and the substrate can be made of silicon or of similar materials.

As described above, the present invention discloses an image display system using polarized illumination light in which the reflected light can be separated from the illumination light and the OFF reflected light is projected away and totally separated from the projection light (ON light).

Since the light path of the illumination light is directed to the deflectable mirror device and is totally separated from the light path of the reflected projection light and the deflecting angle of the mirror pixel can be small, the voltage for controlling the mirror pixel can be reduced. Instead of a voltage difference of at least 25 V between the mirror element and the electrode that is necessary in conventional deflectable mirror devices, in the systems according to this invention, the control voltage can be, for example, 10 V or smaller.

Furthermore, by arranging the illumination light to project substantially at a right angle onto the substantially rectangular deflectable mirror array in the deflectable mirror device, a requirement to align the directions of rotation of the mirror pixels is eliminated. This configuration provides degrees of freedom in the optics design, so that the system can be simple and compact. One mirror array can therefore reflect a plurality of colors. When a plurality of mirror arrays are provided, the ON and OFF directions in the mirror arrays can be different from each other.

Since at least part of unnecessary light, such as the OFF light and diffractive light, is directed away from the projection light path, the contrast of projected images can be improved. Therefore, even when a light source such as a laser light source that likely generates diffractive light, the contrast of the display image can be improved without being adversely affected by the diffractions. Furthermore for a mirror pixel as small as 4 to 10 μm, the effect of diffractive light can be reduced, and the contrast of the image display is improved. Since the illumination light is incident on the deflectable mirror device at right angle, the ON light can efficiently and accurately managed to have a polarization conversion by providing a wave plate that is an integral part with the deflectable mirror device.

By providing a fine structure on the surface of the mirror pixel to allow the surface to behave as a wave plate, one mirror array can modulate light with a plurality of colors.

For convenience of references and for the sake completeness of descriptions, FIG. 1-FIG. 8 described above include optical and functional components and related graphic elements for descriptions that are designated by numeral designations as listed below.
1: random polarized light
2: incident light
3: mirror pixel
4: projection light
5: projection lens
6: off light
11: light source
12: incident light optics
13: TIR prism
14: mirror array
15: deformable mirror device
16: projecting (on) light
17: projection lens
18: off light
19: light dump
20: diffractive light
21: random polarized light
31: mirror array
32: incident light
33: mirror pixel
34: deforming axis
41: incident light
42: PBS
43: quarter wave plate
44: mirror pixel
45: projection light
46: projection lens
51: mirror pixel
52: substrate
53: hinge
54: mirror element
55a: electrode
55b: electrode
56a: stopper
56b: stopper
57: cover glass
58: on light
59: off light
60: intermediate light
61: periodic structure
61a: periodic structure
61b: periodic structure
71: light source
72: incident light optics
73: S polarized incident light
74: Polarizing beam splitter
75: PBS plane
76: deformable mirror device
77: quarter wave retarder
78: intermediate light
79: on light
80: off light 1
81: off light 2
82: projection lens
83: off light 3
84: light dump
85: P polarized light
91a: deformable mirror device for G light
91b: deformable mirror device for R and B light
92a: pixels array for Green
92b: pixels array for Red and Blue
93: mirror element for G
94: mirror element for R
95: mirror element for B
96: deformable axis
97: G color laser light source
98: R color laser light source
99: B color laser light source
100: dichroic mirror
101: dichroic mirror
102: dichroic mirror
103: incident light optics
104: PBS prism
105: PBS plane
106: projection light optics
111a: deformable mirror device for R and B light
111b: deformable mirror device for G light
112a: off light
112b: off light
113: light dump
114: G color laser light source
115: R color laser light source
116: B color laser light source
117: dichroic mirror
118: dichroic mirror
119: dichroic mirror
120: incident light optics
121: PBS prism
122: quarter wave retarder
123: projection light optics
124: package

Although the invention has been described above in detail, the invention is not limited to the above embodiments. Various improvements and changes may of course be made to the extent that they do not depart from the spirit of the invention.

We claim:

1. A display system comprising a deflectable mirror device including a plurality of mirror pixels for receiving a linearly polarized illumination light projected thereon, further comprising:
a polarized light separation plane for separating a reflected light from the illumination light;
a wave plate disposed near the deflectable mirror device; and
a projection lens for projecting the reflected light from the deflectable mirror device,
wherein optical axes of the illumination light and an ON reflected light of said deflectable mirror device are substantially perpendicular to the deflectable mirror device, and an optical axis of an OFF reflected light is inclined relative to an optical axis of an image display projection light path.

2. A display system comprising a deflectable mirror device including a plurality of mirror pixels for receiving a linearly polarized illumination light projected thereon, the display system further comprising:
a projection lens for projecting a reflected light from the deflectable mirror device; and
a polarized light separation plane and a wave plate disposed in a light path common to the illumination light and the reflected light,
wherein an angle between optical axes of the illumination light and an image display projection light path when the mirror pixel is in an ON or an Intermediate state is half an angle u for determining an NA of the projection lens or smaller.

3. A display system comprising a deflectable mirror device including a plurality of mirror pixels of a size between substantially 5 to 10 μm for receiving a multiple color illumination light linearly polarize along a predetermined direction to project thereon, the display system further comprising:
a wave plate disposed near the deflectable mirror device,
the deflectable mirror device modulating and reflecting an incident light passing through the wave plate as a reflected light to pass through the wave plate again;
a polarized light separation plane reflecting or transmitting said reflected light passing through the wave plate again; and
a projection optics for projecting a light projected from a polarized light separation plane.

4. The display system according to claim 3 further comprising at least two deflectable mirror devices for modulating light of at least two different colors, further comprising:
at least two wave plates each disposed near a respective deflectable mirror device have same optical functional characteristics and having directions of optical axes substantially aligned with incident illumination lights of different colors incident to said at least two deflecting mirror devices.

5. The display system according to claim 1 further comprising:
a laser or an LED light source for projecting the linearly polarized illumination light.

6. The display system according to claim 2 further comprising:
a laser or an LED light source for projecting the linearly polarized illumination light.

7. The display system according to claim 3 further comprising:
a laser or an LED light source for projecting the multiple color illumination light linearly polarized along a predetermined direction.

8. The display system according to claim 2 wherein:
the deflectable mirror device has a transparent window, and the wave plate is integrated with the transparent window.

9. The display system according to claim 2 wherein:
the wave plate further comprising a sub-wavelength periodic structure.

10. The display system according to claim 2 wherein:
the wave plate is disposed on a reflective surface of the deflectable mirror device.

11. The display system according to claim 2 wherein:
wherein the wave plate is disposed on a prism disposed near the deflectable mirror device.

12. The display system according to claim 3 wherein:
wherein the wave plate is disposed on a prism disposed near the deflectable mirror device.

13. The display system according to claim 1 wherein:
the illumination light passing through the polarized light separation plane and is directed to the deflectable mirror device,
each of the deflectable mirror pixels is controllable to move to an ON state, an OFF state and an intermediate state between said ON and OFF states, and
an angle of incidence for an optical axis of the reflected light incident onto the polarized light separation plane in the OFF or intermediate state of the deflectable mirror device is smaller than an angle of incidence for the optical axis of the illumination light incident on the polarized light separation plane.

14. The display system according to claim 2 wherein:
the illumination light passing through the polarized light separation plane and is directed to the deflectable mirror device,
each of the deflectable mirror pixels is controllable to move to an ON state, an OFF state and an intermediate state between said ON and OFF states, and
an angle of incidence for an optical axis of the reflected light incident onto the polarized light separation plane in the OFF or intermediate state of the deflectable mirror device is smaller than an angle of incidence for the optical axis of the illumination light incident on the polarized light separation plane.

15. The display system according to claim 3 wherein:
the illumination light passing through the polarized light separation plane and is directed to the deflectable mirror device,
each of the deflectable mirror pixels is controllable to move to an ON state, an OFF state and an intermediate state between said ON and OFF states, and
an angle of incidence for an optical axis of the reflected light incident onto the polarized light separation plane in the OFF or intermediate state of the deflectable mirror device is smaller than an angle of incidence for the optical axis of the illumination light incident on the polarized light separation plane.

16. The display system according to claim 1 wherein:
the illumination light reflecting off the polarized light separation plane and is directed to the deflectable mirror device,
each of the deflectable mirror pixels has an ON state, an OFF state and an intermediate state between said ON and OFF states,
an angle of incidence for an optical axis of the reflected light incident on the polarized light separation plane in the OFF or intermediate state is larger than the angle of incidence for an optical axis of the illumination light incident on the polarized light separation plane.

17. The display system according to claim 2 wherein:
the illumination light reflecting off the polarized light separation plane and is directed to the deflectable mirror device,
each of the deflectable mirror pixels has an ON state, an OFF state and an intermediate state between said ON and OFF states,
an angle of incidence for an optical axis of the reflected light incident on the polarized light separation plane in the OFF or intermediate state is larger than the angle of incidence for an optical axis of the illumination light incident on the polarized light separation plane.

18. The display system according to claim 3 wherein:
the illumination light reflecting off the polarized light separation plane and is directed to the deflectable mirror device,
each of the deflectable mirror pixels has an ON state, an OFF state and an intermediate state between said ON and OFF states,
an angle of incidence for an optical axis of the reflected light incident on the polarized light separation plane in the OFF or intermediate state is larger than the angle of incidence for an optical axis of the illumination light incident on the polarized light separation plane.

19. The display system according to claim 1 wherein:
the optical axis of an OFF light reflected from said deflectable mirror device is not intersected with the polarized light separation plane.

20. The display system according to claim 2 wherein:
the optical axis of an OFF light reflected from said deflectable mirror device is not intersected with the polarized light separation plane.

21. The display system according to claim 3 wherein:
the optical axis of an OFF light reflected from said deflectable mirror device is not intersected with the polarized light separation plane.

22. The display system according to claim 1 wherein:
wherein an OFF light reflected from said deflectable mirror device is absorbed in a plane intersected the polarized light separation plane or passes through a plane intersecting the polarized light separation plane.

23. The display system according to claim 2 wherein:
wherein an OFF light reflected from said deflectable mirror device is absorbed in a plane intersected the polarized light separation plane or passes through a plane intersecting the polarized light separation plane.

24. The display system according to claim 3 wherein:
wherein an OFF light reflected from said deflectable mirror device is absorbed in a plane intersected the polarized light separation plane or passes through a plane intersecting the polarized light separation plane.

25. The display system according to claim 1 wherein:
the deflectable mirror pixel is controlled to move to an angular position between an ON and OFF states with at least part of the reflected light reflecting toward the polarized light separation plane.

26. The display system according to claim 2 wherein:
the deflectable mirror pixel is controlled to move to an angular position between an ON and OFF states with at least part of the reflected light reflecting toward the polarized light separation plane.

27. The display system according to claim 3 wherein:
the deflectable mirror pixel is controlled to move to an angular position between an ON and OFF states with at least part of the reflected light reflecting toward the polarized light separation plane.

28. A display system comprising a deflectable mirror device including a plurality of mirror pixels for receiving a laser illumination light projected thereon, the display system further comprising:
a projection lens for projecting a reflected light from the deflectable mirror device; and
a polarized light separation plane disposed in a light path common to the illumination light and the reflected light, wherein an angle between optical axes of the illumination light and an image display projection light path when the mirror pixel is in an ON or an Intermediate state is half an angle u for determining an NA of the projection lens or smaller.
